(19) United States
(12) Patent Application Publication
(10) Pub. No.: US 2026/0078832 A1
(43) Pub. Date: Mar. 19, 2026

(54) VALVE CARTRIDGE

(71) Applicant: Neoperl GmbH, Müllheim (DE)

(72) Inventor: Werner Kury, Müllheim (DE)

(73) Assignee: Neoperl GmbH, Neoperl GmbH (DE)

(21) Appl. No.: 19/107,130

(22) PCT Filed: Sep. 15, 2023
(86) PCT No.: PCT/EP2023/075544

§ 371 Date: Feb. 27, 2025

(30) Foreign Application Priority Data
Sep. 19, 2022 (DE) 10 2022 123 992.6

(51) Int. Cl. F16K 11/00

(52) U.S. Cl. CPC F16K 19/006; F16K 2200/501

(57) ABSTRACT

A valve cartridge (1) with an operating element-side housing part (2) that is captively connected to a connection-side housing part (3), in which at least one plug-in receptacle (4) is formed in the connection-side housing part (3).

### CROSS-REFERENCE TO RELATED APPLICATION

This application is a 371 National Phase of PCT/EP2023/075544, filed Sep. 15, 2023, which claims priority from German Patent Application No. 10 2022 123 992.6, filed September 19, 2022, both of which are incorporated herein by reference as if fully set forth.

### TECHNICAL FIELD

The invention relates to a valve cartridge.

### BACKGROUND

Valve cartridges are known, for example in single-lever mixing valves or in push-push valves with or without additional temperature and/or quantity adjustment.

Valve cartridges have a housing that holds the individual parts together even when removed.

It has become customary to insert the valve cartridges into corresponding cup-shaped receptacles, each having hose receptacles or hose connections, in order to establish a fluidic connection.

### SUMMARY

The invention is based on the object of simplifying the structural design of a valve cartridge.

To achieve the stated object, one or more of the features disclosed herein are provided according to the invention. In particular, the valve cartridge is characterized in that at least one plug-in receptacle is formed in the connection-side housing part. This can, for example, make it possible to connect hoses to the valve cartridges. The invention makes it possible to dispense with a separate cartridge receptacle, on which hose connections are formed or to which hoses are fastened.

One advantageous configuration provides for the plug-in receptacle to be configured for preferably axially oriented plug-in connection of a connection hose. This can, for example, make it possible to plug a connection hose into the plug-in receptacle.

One advantageous configuration provides for the housing parts to be connected by means of a captive-securing means. This can, for example, make it possible to captively connect an operating element-side housing part to the connection-side housing part. This can be achieved, for example, via a snap-action or latching connection.

One advantageous configuration provides for at least two plug-in receptacles to be formed. This can, for example, make it possible to fasten two connection hoses to the valve cartridge. In particular, it may be provided that at least three plug-in receptacles are formed. This can, for example, make it possible to fasten three connection hoses to the valve cartridge. The plug-in receptacles are designed in particular for a hot-water hose, a cold-water hose and a mixed-water hose. The valve cartridge thus allows hot and cold water to be mixed and the mixed water to be discharged via the mixed-water hose.

One advantageous configuration provides for at least one plug-in receptacle to have a pull-out prevention means. This can, for example, make it possible to ensure that the connection hoses that are plugged in the plug-in receptacle cannot release of their own accord or be pulled out.

One advantageous configuration provides for the at least one plug-in receptacle to project beyond a support surface of the connection-side housing part. This can, for example, make it possible to form the plug-in receptacle outside the operating element-side housing part. In particular, it may be provided that the at least one plug-in receptacle protrudes from the support surface, which forms a housing bottom. This can, for example, make it possible to easily plug the connection hoses into the plug-in receptacles. In particular, it is provided that the at least one plug-in receptacle protrudes in a tubular manner from the support surface, which forms a housing bottom. This can, for example, make it possible to fasten tubular, cross-sectionally round connection hoses in the plug-in receptacle.

One advantageous configuration provides for the operating element-side housing part to form at least one aperture for an operating element. This can make it possible, for example, to operate the valve cartridge.

One advantageous configuration provides for at least two disks for fluid control, which are movable relative to one another, to be arranged, in particular in contact with one another, in the interior. This can make it possible to adjust, for example, a mixing ratio of hot and cold water as well as a water pressure in the valve cartridge. In particular, it may be provided that the at least two disks in the interior, which are movable relative to one another, are made of ceramic. This minimizes, for example, the build-up of lime on the ceramic disks.

One advantageous configuration provides for at least one connection hose to be secured in the plug-in receptacle by a spring clip. This can provide, for example, a pull-out prevention means for the connection hose. In particular, the cold-water hose and/or hot-water hose is secured in the plug-in receptacle by a spring clip. These water hoses are generally under a high pressure of 2 to 8 bar. Securing the hoses by means of a spring clip that engages in the grooves of the hose nipples ensures that the hoses are held very securely in the plug-in receptacles.

One advantageous configuration provides for at least one connection hose to be secured in the plug-in receptacle by claws. This can provide, for example, a pull-out prevention means for the connection hose by the claws in the plug-in receptacle being configured in such a way that they counteract a tensile force, in the opposite direction to the plug-in direction, and prevent the hose from being pulled out. In particular, it is provided that at least the mixed-water hose is secured in the plug-in receptacle by claws. This can make it possible, for example, to advantageously secure the mixed-water hose, which is generally at a lower pressure than the cold- and hot-water hoses.

One advantageous configuration provides for connection hoses to comprise hose nipples with grooves. Securing elements such as spring clips can engage in the grooves to provide a pull-out prevention means, thus securing the connection hoses.

One advantageous configuration provides for at least one connection hose to be secured in the plug-in receptacle by claws and a spring clip. This can, for example, make it possible for the connection hose to be secured particularly advantageously in the plug-in receptacle due to the combination of the two securing elements.

In may be provided, in this respect or in general, that at least one connection hose is rotatable relative to the plug-in receptacle. Thus, for example, torsional stresses on the connection hose can be reduced. The rotatability can be achieved, for example, by the claws sliding on the connection hose and/or by rotatability of a claw carrier, on which the claws are formed, in a hold-down device, which retains the claw carrier. The hold-down device may be designed, for example, such that the claw carrier presses the claws into the connection hose in the event of a pull-out load. The hold-down device and the claw carrier can interact in a manner known per se in such a way that the connection hose can be pulled out of the claw carrier if the claw carrier is held in opposition to the pull-out direction.

### BRIEF DESCRIPTION OF THE DRAWINGS

The invention will now be described in more detail on the basis of an exemplary embodiment, but is not restricted to said exemplary embodiment. Further exemplary embodiments emerge from the combination of the features of individual or multiple claims with one another and/or with individual or multiple features of the exemplary embodiment.

In the figures:

FIG. 1 shows a valve cartridge according to the invention in a three-dimensional oblique view with connection hoses,

FIG. 2 shows a view of the plug-in receptacles of the connection-side housing part from FIG. 1,

FIG. 3 shows a view of the inside of the connection-side housing part from FIG. 1,

FIG. 4 shows a valve cartridge according to the invention in a three-dimensional oblique view with connection hoses,

FIG. 5 shows a variant of the valve cartridge from FIG. 4, and

FIG. 6 shows a further variant of the valve cartridge from FIG. 4.

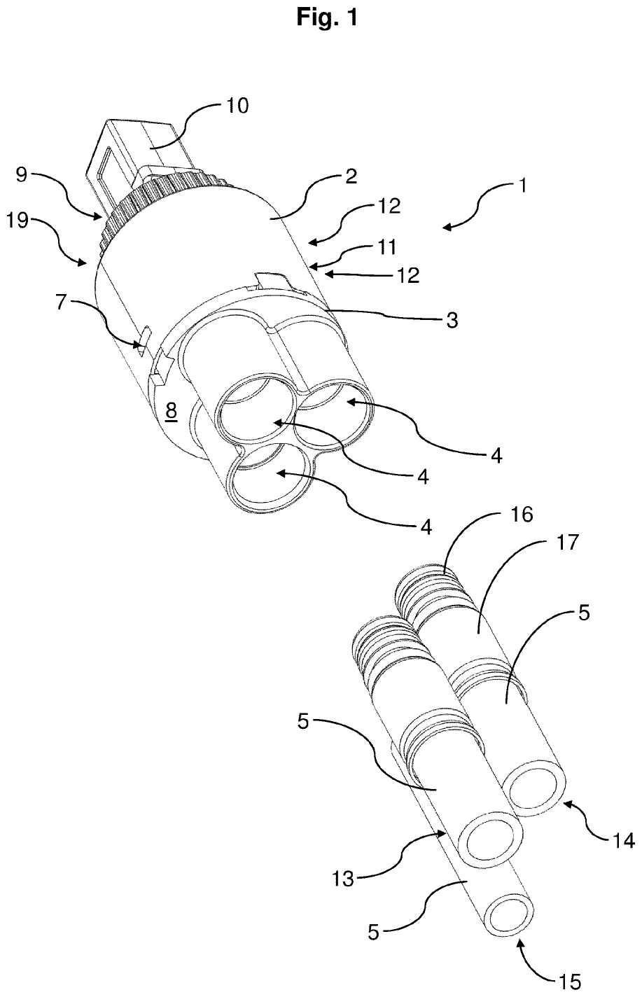

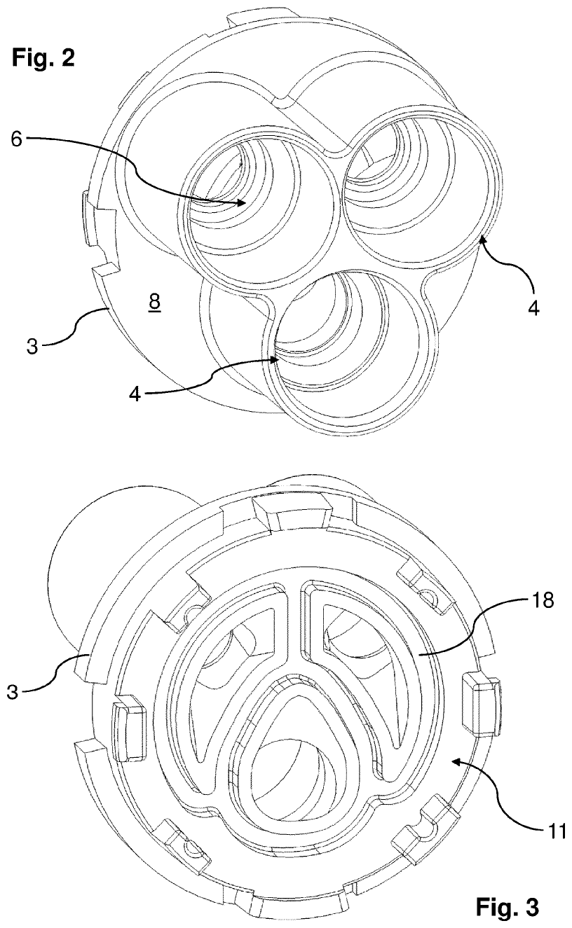

### DETAILED DESCRIPTION

The valve cartridge 1 has an operating element-side housing part 2 that is captively connected to a connection-side housing part 3.

At least one plug-in receptacle 4 for a connection hose 5 is formed in the connection-side housing part 3. The plug-in receptacle 4 and housing part 3 are thus connected in one piece and formed as a common injection-molded part.

The plug-in receptacle 4 is configured for preferably axially oriented plug-in connection of a connection hose 5. In this example, the connection hoses 5 are plugged in; in further examples, they are plugged on.

The housing parts 2, 3 are connected by means of a captive securing means 7 (e.g. a snap-action connection).

In the example, at least two, in particular at least three, plug-in receptacles 4 are formed, in particular for a hot-water hose 13, a cold-water hose 14 and a mixed-water hose 15.

Each of the plug-in receptacles 4 has a pull-out prevention means 6.

The plug-in receptacles 4 are each configured for non-releasable plug-in connection, in particular via the pull-out prevention means 6. The pull-out prevention means may have, for example, a securing element which engages in a groove 16 of the hose nipples 17 or interlocks with the connection hose 5.

Each plug-in receptacle 4 protrudes from a support surface 8 of the connection-side housing part 3. The support surface 8 can be used in this case for clamping the valve cartridge 1 in a holder (not shown, for example on a sanitary fitting). The valve cartridge 1 here is clamped between the support surface 8 and a mating surface 19 (shoulder) on the housing part 2.

Each plug-in receptacle 4 thus protrudes, preferably in a tubular manner, from the support surface 8, which forms a housing bottom.

The operating element-side housing part 2 forms at least one aperture 9 for an operating element 10.

At least two disks 12 (covered by housing part 2) for fluid control, which are movable relative to one another and preferably made of ceramic, are arranged, in particular in contact with one another, in the interior 11 (inside the cup-shaped housing part 2).

These disks can directly or indirectly abut sealing elements, which are inserted in a groove 18, on the housing part 3.

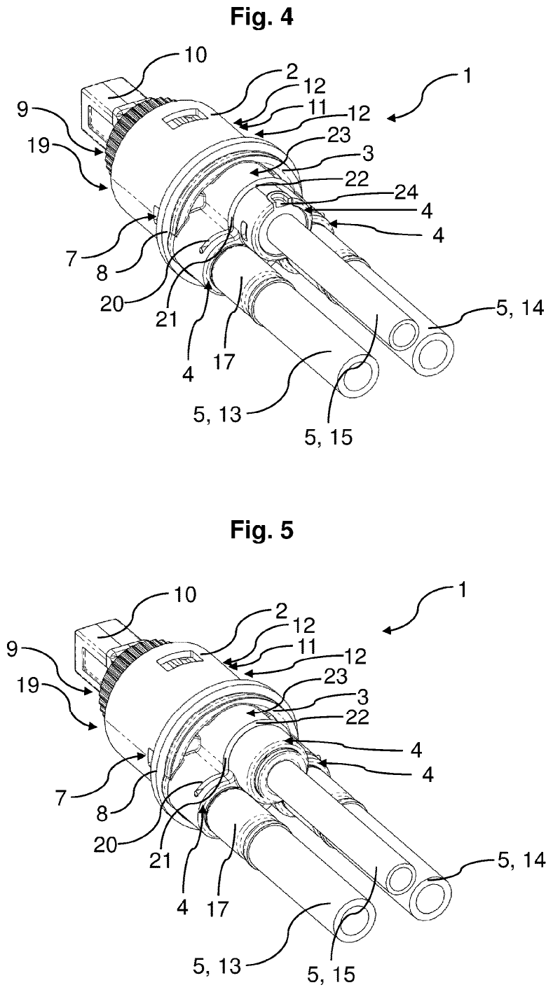

The embodiment of the valve cartridge 1 shown in FIG. 4 shows the connection-side housing part 3 with connection hoses 4 inserted in the plug-in receptacles 4. The connection hoses 4 have hose nipples 17 with a groove 16 in which a spring clip 21 engages and secures the connection hoses 4. The spring clip 21 serves as a securing element in this respect. The connection-side housing part 3 and the plug-in receptacles 4 have receptacles 20 for the spring clip 21, so that the spring clip can be inserted there to secure the connection hoses 4. The receptacles 20 are formed in the plug-in receptacles 4 for the hot-water hose 13 and the cold-water hose 14. In the embodiment shown, cold-water hose 14 and hot-water hose 13 are secured in the plug-in receptacle 4 by a spring clip 21.

The spring clip 21 is guided around the outside of the plug-in receptacle 4 of the mixed-water hose 15 and forms an arc 22.

The arc 22 extends from the spring-clip insertion direction around the center 23 of the plug-in receptacle 4 for the mixed-water hose 15, so that the arc 22 engages behind the mixed-water hose 15 and narrows behind the mixed-water hose 15. A narrowing is thus formed.

The spring clip 21 fixes the connection hoses 5 in place through the receptacles 20 in the connection-side housing part 3.

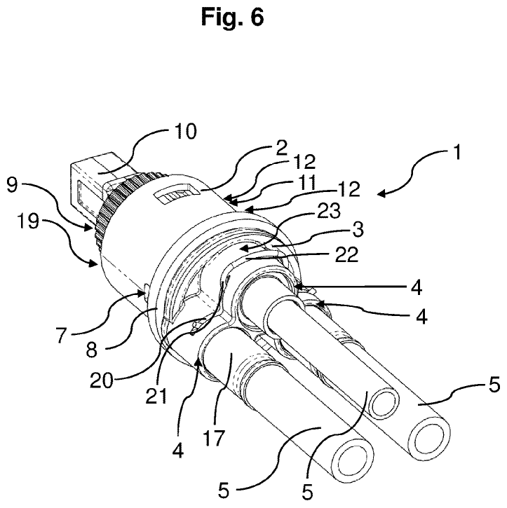

The plug-in receptacle 4 of the mixed-water hose 15 in FIG. 4 has an additional locking means 24. The embodiments shown in FIG. 5 and FIG. 6 do not require the locking means 24.

FIG. 6 shows a further embodiment of the valve cartridge 1, in which the receptacle 20 also extends to the plug-in receptacle 4 of the mixed-water hose 15.

The spring clip 21 thus clasps the mixed-water hose 15 and as a result generates a holding force, which fixes the spring clip 21 in its insertion direction, on the mixed-water hose 15.

In an embodiment that is not shown, at least one connection hose 15, in particular the mixed-water hose 15, is secured in the plug-in receptacle 4 by claws. In another embodiment that is not shown, at least one connection hose is secured in the plug-in receptacle 4 by claws and the spring clip 21.

A valve cartridge 1 with an operating element-side housing part 2 that is captively connected to a connection-side housing part 3 is characterized in that at least one plug-in receptacle is formed in the connection-side housing part 3.

### LIST OF REFERENCE SIGNS

1 Valve cartridge
2 Operating element-side housing part
3 Connection-side housing part
4 Plug-in receptacle
5 Connection hose
6 Pull-out prevention means
7 Captive-securing means
8 Support surface
9 Aperture
10 Operating element
11 Interior
12 Disk
13 Hot-water hose
14 Cold-water hose
15 Mixed-water hose
16 Groove
17 Hose nipple
18 Groove
19 Mating surface
20 Receptacle
21 Spring clip
22 Arc
23 Center
24 Locking means

1. A valve cartridge (1), comprising:
an operating element-side housing part (2);
a connection-side housing part (3), the operating element-side housing part (2) being captively connected to the connection-side housing part (3); and
at least one plug-in receptacle (4) is formed in the connection-side housing part (3).

2. The valve cartridge (1) as claimed in claim 1, wherein the plug-in receptacle (4) is configured for plug-in connection of a connection hose (5).

3. The valve cartridge (1) as claimed in claim 1, the operating-side and connection-side housing parts (2, 3) are connected by a snap-action connection (7).

4. The valve cartridge (1) as claimed in claim 1, wherein the at least one plug-in receptacle comprises at least two plug-in receptacles (4).

5. The valve cartridge (1) as claimed in claim 1, wherein the at least one plug-in receptacle (4) has a pull-out prevention element (6).

6. The valve cartridge (1) as claimed in claim 1, wherein the plug-in receptacle (4) is configured for non-releasable plug-in connection.

7. The valve cartridge (1) as claimed in claim 1, wherein the at least one plug-in receptacle (4) projects beyond a support surface (8) of the connection-side housing part (3).

8. The valve cartridge (1) as claimed in claim 1, wherein the operating element-side housing part (2) forms at least one aperture (9) for an operating element (10).

9. The valve cartridge (1) as claimed in claim 1, further comprising at least two disks (12) for fluid control, which are movable relative to one another arranged in an interior (11) of at least one of the operating-side or connection-side housing parts (2, 3).

10. The valve cartridge (1) as claimed in claim 1, further comprising at least one connection hose secured in the plug-in receptacle (4) by a spring clip (21).

11. The valve cartridge (1) as claimed in claim 1, further comprising at least one connection hose (5) secured in the plug-in receptacle (4) by claws.

12. The valve cartridge (1) as claimed in claim 1, further comprising at least one connection hose (5) secured in the plug-in receptacle (4) by claws and a spring clip (21).

13. The valve cartridge (1) as claimed in claim 1, further comprising at least one connection hose (5) that is rotatable relative to the plug-in receptacle (4).

14. The valve cartridge (1) as claimed in claim 1, wherein the at least one plug-in receptacle comprises plug-in receptacles (4) for a hot-water hose (13), a cold-water hose (14), and a mixed-water hose (15).

15. The valve cartridge (1) as claimed in claim 7, wherein the at least one plug-in receptacle (4) protrudes from the support surface (8), which forms a housing bottom.
